(19) United States
(12) Patent Application Publication
(10) Pub. No.: US 2011/0293887 A1
(43) Pub. Date: Dec. 1, 2011

(54) METHOD AND APPARATUS FOR IMPRINTING A THREE-DIMENSIONAL DESIGN INTO A SYNTHETIC MATERIAL

(75) Inventor: Timothy James Sommerfeld, Ariss (CA)

(73) Assignee: RESEARCH IN MOTION LIMITED, Waterloo (CA)

(21) Appl. No.: 12/789,793

(22) Filed: May 28, 2010

(51) Int. Cl. D06N 3/00; B29C 35/08

(52) U.S. Cl. 428/141; 264/400

(57) ABSTRACT

A method, product, and apparatus for imprinting a three-dimensional design into a textured surface of a synthetic material includes laser-ablating the design into the synthetic material and then imprinting the design. The design is laser-ablated into the textured surface of the synthetic material by vaporizing a portion of the material in an x-y shape of the design to a predetermined z-depth. The vaporized portions of the material form a design-shaped void that extends a prescribed distance into the textured surface of the synthetic material. In one implementation, the design is imprinted by inserting a tool in the design-shaped void of the laser-ablated design. The tool has a substantial conformance fit with the void, thereby forming a substantially distortion-free imprint of the design on the synthetic material.

### FIELD OF TECHNOLOGY

The present disclosure relates generally to methods of imprinting synthetic material. More specifically, the present disclosure relates to imprinting a three-dimensional design into a textured surface of a synthetic material.

### BACKGROUND

Synthetic material, such as artificial or synthetic leather, appears to have a genuine finish, but the actual material is a material with a composite layer or a blend of materials that gives the appearance of the genuine leather. Synthetic material can also be considered artificial material, or faux material. These synthetic materials can simulate different types of leather or different natural materials.

Instead of being made of animal skin, synthetic leather is made of other materials or a blend of polymers that receives numerous treatments so that the resulting material replicates the look of real or genuine leather and some of the common attributes of genuine leather. Synthetic leather is typically made from plastics. Some synthetic leather can be made solely of materials such as polyvinyl chloride (PVC). Other types of synthetic leather can include cloth material, such as polyester or cotton that is coated with substances to replicate the look of leather. For example, one type of synthetic leather called leatherette is made by covering a fabric base with plastics. In leatherette, the fabric can be made of a natural or synthetic fiber which is then covered with a soft PVC layer.

### BRIEF DESCRIPTION OF THE DRAWINGS

Implementations of the present disclosure will now be described, by way of example only, with reference to the attached Figures, wherein:

FIG. 1 is a front view of an exemplary electronic device;

FIG. 2 is an example of sheet of synthetic leather having a distorted design resulting from a traditional heated imprinting or branding or branding method typically used on genuine leather;

FIG. 3 is a cross-section view of synthetic material having a textured surface characterized by peaks and valleys;

FIG. 4 is an illustration of the synthetic material depicted in FIG. 3 after a portion of the synthetic material has been laser-ablated;

FIG. 5 is a cross-section view of synthetic material in accordance with an alternative implementation of the present disclosure, before a portion of the synthetic material has been laser-ablated;

FIG. 6 is an illustration of the layer depicted in FIG. 5 after a portion of the synthetic material has been laser-ablated;

FIG. 7 is a perspective view of an exemplary layer of synthetic material covering the back of an electronic device and having a design laser-ablated onto the synthetic material;

FIG. 8 is a perspective view of an exemplary tool for imprinting a design on a synthetic material after a portion of the material has been laser-ablated;

FIG. 9 is a perspective view of the layer of synthetic material illustrated in FIG. 7 after a portion of the synthetic material has been imprinted by the tool depicted in FIG. 8; and

FIG. 10 a close-up view of the design depicted in FIG. 9; and

FIG. 11 is a flow chart of the method of imprinting a three-dimensional design into a synthetic material, in accordance with an exemplary implementation of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the implementations described herein. However, it will be understood by those of ordinary skill in the art that the implementations described herein can be practiced without these specific details. In other instances, methods, procedures and components have not been described in detail so as not to obscure the related relevant feature being described. Also, the description is not to be considered as limiting the scope of the implementations described herein.

Several definitions that apply throughout this document will now be presented. The word “synthetic” can also mean artificial, faux, fake, imitation, or the like. The term “synthetic leather” can include pleather, artificial leather, leatherette, polymer sheets having a leather appearance, Koskin, poromeric imitation leather, a polymer of uniform synthetic material having a textured layer resembling leather, or the like. The terms “ablation,” “ablate,” or “ablating” are defined as vaporizing, sublimating, or evaporating a material very quickly using a laser while not permitting the material to liquefy or melt. The term “imprinting” includes embossing, debossing, impressing, stamping, branding, or any other method of forming a textured, raised, or substantially three-dimensional design or image, into, out of, or onto the surface of a material. The term “textured surface” is defined as a surface characterized by peaks and valleys, including uniformly shaped and spaced peaks and valleys and non-uniformly shaped and spaced peaks and valleys. The phrase “textured surface” can also include a surface characterized by hills and dips, plateaus and basins, steps and recesses, or any other shapes, so that the surface has a feel other than smooth. It is contemplated that “peaks” are portions of a surface that are at a higher height or elevation than at least two adjacent portions or points. It is also contemplated that “valleys” are portions of a surface that are at a lower elevation or depth than at least two adjacent portions or points. In other words, “peaks” and “valleys” refer to a surface having high points and portions, as well as a low points and portions. The phrase “strike zone” refers to the area of a surface or material where an ablation laser will strike or ablate the material. The term “skin” refers to a top layer, a layering, a single layer of material, a covering, or a sheet of material that covers a surface of an object.

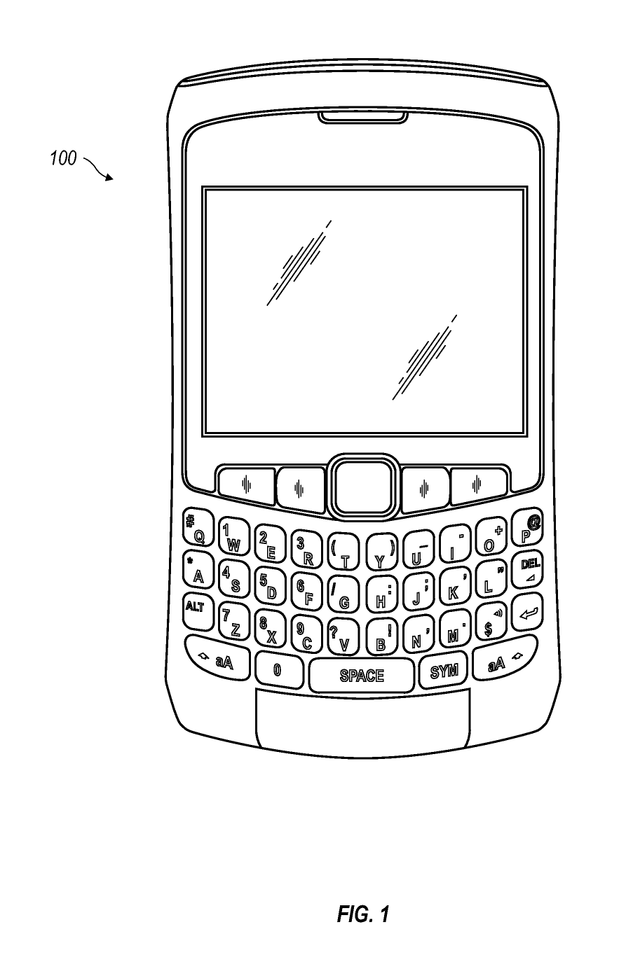

For purposes of brevity and as an example, this disclosure will focus on synthetic leather. However, one of ordinary skill in the art will appreciate that other synthetic, artificial, or faux materials, such as faux suede, are considered within the scope of this disclosure. Additionally, while the following disclosure discusses a method of imprinting the synthetic leather covering a back cover a handheld mobile device, one of ordinary skill in the art will appreciate that the method of imprinting synthetic leather can be applied to any object that has a layer of synthetic leather, as synthetic leather is used on a wide variety of products. For example, synthetic leather can be used for clothing, shoes, computer laptop cases, CD wallets, book covers, wallets, and the like. In one example, synthetic leather can be used as a skin for the back cover of mobile devices, such as a cellular phone, a personal digital assistant (PDA), a portable MP3 player, or a smartphone, or a handheld communication device 100, such as the one illustrated in FIG. 1.

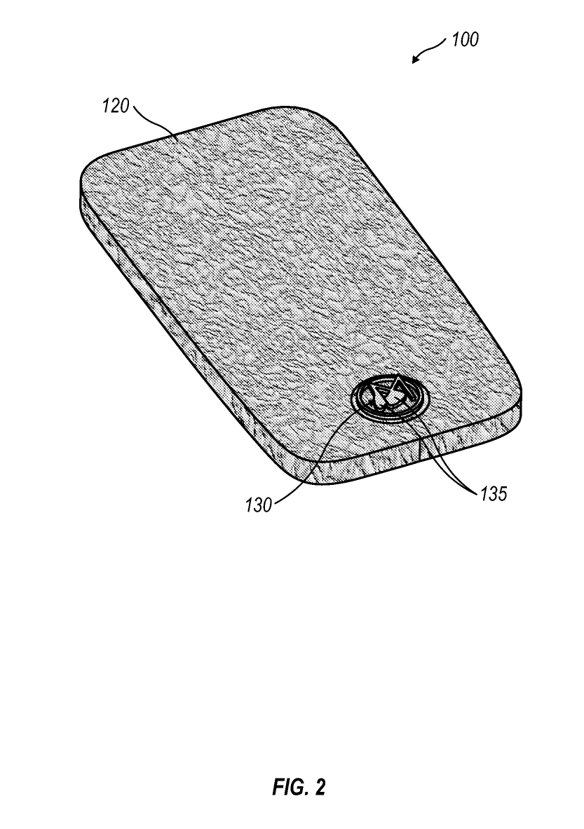

As synthetic leather is designed to mimic real or genuine leather, there is a demand that synthetic leather include designs, embossing, imprints, and brands that can be found on genuine leather products. However, because synthetic leather is typically made of plastic, the traditional methods of embossing, imprinting, and branding natural or genuine leather cannot be used on synthetic leather. For example, branding and embossing often requires simply placing a combination of heat and pressure directly on the material. If heat and pressure are placed on synthetic leather which contains plastic, the heat causes the plastic to melt which can distort the design to be branded, embossed, or imprinted on the synthetic leather. For example, FIG. 2 is an illustration of a skin 120 for the back cover of the handheld communication device 100 illustrated in FIG. 1, wherein the skin 120 has been imprinted with a design 130 using a heated embossing method. The skin 120 is made of synthetic leather. As seen in FIG. 2, the design 130 is misshapen, distorted, and comprises a build-up 135 of melted plastic at the bottom of the design 130. In FIG. 2, while embossing the skin 120 of the back cover resulted in displacement of some of the synthetic leather, the design 130 is distorted due to the plastic in the synthetic leather. Additionally, heating the plastic in the synthetic leather can melt the plastic so much that the resulting material no longer looks like genuine leather nor has the texture of genuine leather. As genuine leather is a stable material, the heat from the branding or embossing does not melt the leather as can happen with synthetic leather. Thus, there is difficulty in imitating branded designs, imprinted designs, and embossed designs typically found in genuine leather products in synthetic leather products.

Thus, a method for imprinting a three-dimensional design into a textured surface of a synthetic material is disclosed herein. The method can include laser-ablating a design into the textured surface of a synthetic material by vaporizing a portion of the material in an x-y shape of the design to a predetermined z-depth, thereby forming a design-shaped void that extends a prescribed distance into the textured surface of the synthetic material. The method also includes inserting a tool having a substantial conformance fit with the design-shaped void into the ablated design-shaped void, thereby forming a substantially distortion-free imprint of the design on the synthetic material. In at least one implementation, the tool is heated to a temperature that is sufficient to induce plastic deformation in the synthetic material when the tool contact engages the material for a prescribed period of stamp-time. In another implementation, the method can include positioning a sheet of synthetic material having a textured surface in the strike zone of an ablating laser. In yet another implementation, the method can include ablating the strike zone to extend a design-shaped void into the textured surface of the synthetic material at least as deep as the valleys to be crossed by the void.

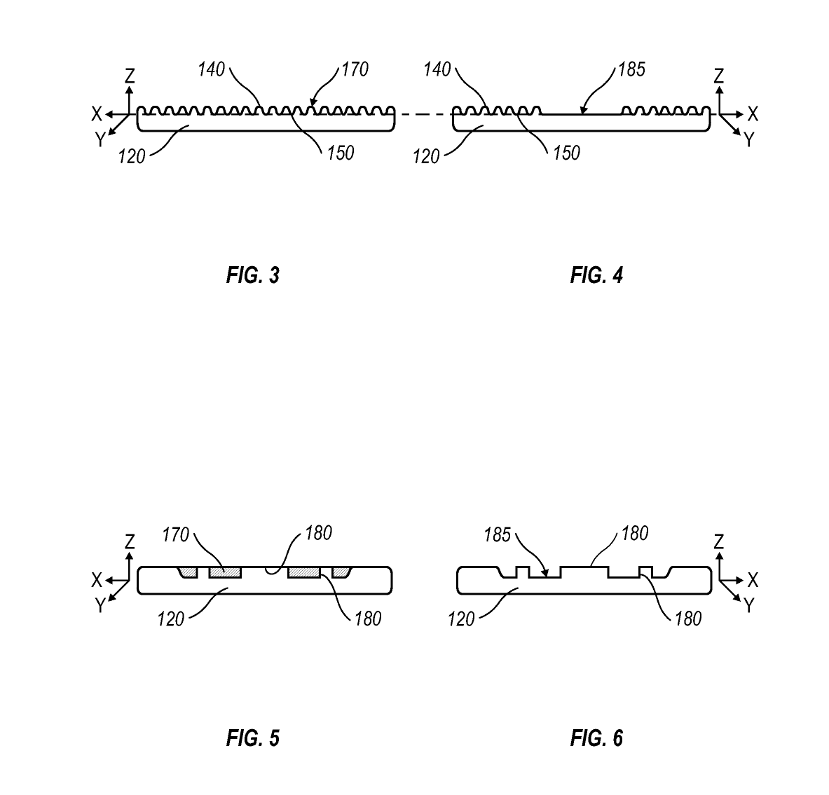

The method and apparatus for imprinting a three-dimensional design into a textured surface of a synthetic material will be described with reference to FIGS. 3-10. Additionally, as presented herein, a product resulting from the process is described as well. FIGS. 3-4 are illustrations of the cross-section of a layer 120 of synthetic material covering a back cover of an electronic device 100, where the cross-section is taken along the horizontal x-direction axis of the electronic device. The synthetic material illustrated in FIGS. 3-4 is synthetic leather. As illustrated in FIGS. 3-4, the layer 120 is characterized by a plurality of peaks 140 and valleys 150 that are evenly and uniformly shaped and spaced. However, one of ordinary skill in the art will appreciate that the peaks 140 and valleys 150 can also be unevenly and non-uniformly shaped and spaced and can be any other shape or pattern that provides a textured surface for the synthetic material. The peaks 140 and valleys 150 give the synthetic leather a leather-like appearance. Additionally, it is contemplated that different patterns of peaks 140 and valleys 150 can be arranged so as to represent different types of leather. While the illustrated example has a saw-tooth like appearance, the peaks 140 and valleys 150 as contemplated herein can include multiple types of peaks 140 and valley 150. For example, the peaks 140 can be flat, pointed, sloped, or other configurations. Likewise, the valleys 150 can have similar shapes. The width of each peak 140 or valley 150 can vary as well. To simulate cowhide leather, dimples (i.e., valleys) can be dispersed. To simulate alligator leather, the peaks can be broad plateaus, and the valleys can be narrow.

FIG. 3 is an illustration of a layer 120 of synthetic leather before a portion of the synthetic leather has been laser-ablated. FIG. 4 is an illustration the layer 120 of synthetic leather depicted in FIG. 3 after a portion of the synthetic leather has been laser-ablated. In FIG. 3, the strike-zone portion 170 of the synthetic leather is the portion to be laser-ablated when placed under the strike zone of the ablating laser. When the ablating laser contacts the strike-zone portion 170, surfaces of the strike-zone portion 170 are vaporized to form a design-shaped void 185 that will result in a design on the synthetic material. The ablating laser can be a fiber laser, a carbon dioxide laser, yttrium-aluminum-garnet (YAG) laser, or other similar laser.

As shown in FIG. 4, the design-shaped void 185 extends into the textured surface 120 at least as deep as the valleys 150 crossed by the void 185. In other words, the layer 120 is ablated just to the point of the depth of the valleys 150 to expose the subsurface of the synthetic material. While FIGS. 3-4 illustrate valleys 150 that have the same depth, one of ordinary skill in the art will appreciate that the valleys 150 can vary in depth. Thus, the design-shaped void 185 would be laser-ablated to extend into the textured surface at least as deep as the valley that will cross the design-shaped void 185, and that valley may not necessarily be the deepest valley of the synthetic material. In the particular example illustrated in FIG. 4, the ablating laser vaporizes the layer 120 to expose the subsurface of the synthetic material and to smooth the bottom of the design-shaped void 185. While the depth illustrated in FIGS. 3-4 is the depth of the valley, it is contemplated that in designs having valleys of various depths, it is not necessary to extend the void 185 to the depth of deepest valley, but rather extending the void 185 to an intermediary valley or the valley(s) which the design-shaped void 185 crosses is appropriate.

In at least one implementation, a three-dimensional design 180 can be laser-ablated into the strike-zone portion 170 of a layer 120 of synthetic leather, as illustrated in FIGS. 5-6. FIG. 5 illustrates another example of a cross-section of a layer 120 of synthetic leather before the strike-zone portion 170 of the synthetic leather has been laser-ablated, where the cross-section is taken along an x-direction axis of the layer 120. FIG. 6 illustrates the layer 120 of synthetic material after the strike-zone portion 170 of the synthetic leather has been laser-ablated to have a design 180 formed in the synthetic leather. In FIG. 6, a design 180 is laser-ablated into the textured surface of the synthetic leather by laser-ablating an x-y shape of the design 180 to a predetermined z-depth, thereby resulting in a three-dimensional design 180 outlined by a design-shaped void 185 that extends a prescribed distance into the textured surface of the layer 120 of synthetic leather.

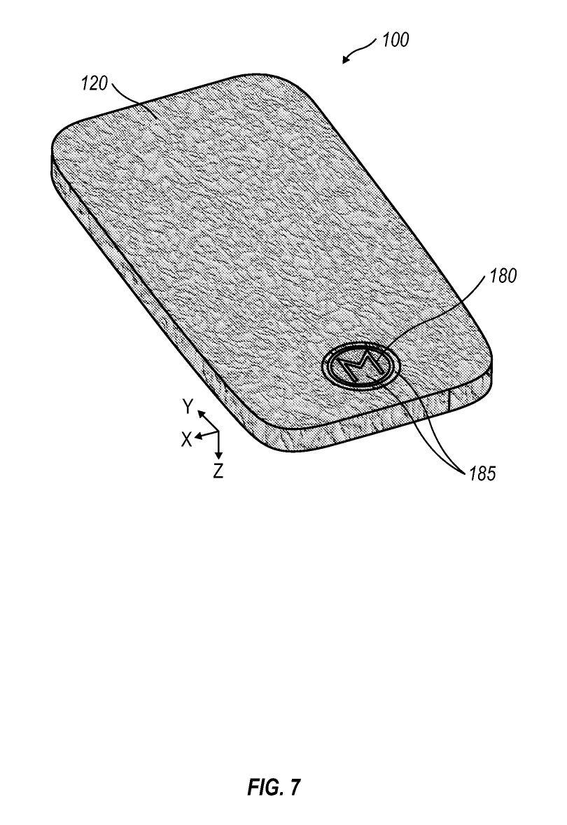

In at least one alternative implementation, the ablating laser traces a design-shaped void 185 that outlines the shape of a design 180 on the strike zone portion 170 so that the design 180 is three-dimensional and appears to protrude in an upwards z-direction away from the design-shaped void 185. In other words, the ablating laser ablates the design 180 into the surface of the synthetic material and vaporizes areas of the strike-zone portion 170 in an x-y shape of the design 180 to a predetermined z-depth to provide the design-shaped void 185 that gives the design 180 a three-dimensional appearance. For example, in FIG. 6, the design-shape void 185 outlines the design 180, and the design 180 protrudes upward in the z-direction away from the design-shaped void 185, thereby creating a three-dimensional design. In this implementation, after the layer 120 has been laser-ablated, the resulting design 180 has the appearance of a three-dimensional design 180 but may have soft or not-well-defined edges, as will be discussed with reference to FIG. 7. The shape and depth of the laser-ablated design 180 and the design-shaped void 185 depend on the texture of the synthetic material which can affect the strength and power of the ablating laser, the number of passes that the laser takes across the strike-zone portion of the synthetic material, and the time the laser is exposed to the surface of the synthetic material. One of ordinary skill in the art would appreciate that the strength of the laser be enough to bring the synthetic material past the material's melting point to vaporize the synthetic material but not so proximate to the melting point that the synthetic material begins to melt; otherwise bubbling of the material may occur and distort or damage the design 180. Essentially, the power of the ablating laser should be enough to instantaneously vaporize the design 180 into the synthetic material so that material surrounding the design 180 is not heated. However, one of ordinary skill in the art would understand that the ablating laser should be exposed to the surface for a time that permits the synthetic material to vaporize but not so long that the material begins to melt and distort the design 180. In other words, the power, time, and pressure parameters are unique to each synthetic material and the depth of the cut required to ablate below the textured surface.

FIG. 7 is an illustration of the back cover of an electronic device 100 having a layer 120 of synthetic leather. As shown in FIG. 7, a design 180 has been laser-ablated towards the bottom of the back cover of the electronic device 100. While the design 180 illustrated in FIG. 7 is an M-shape encompassed by a circular ring, it will be appreciated that the design 180 can have any shape, simple or ornate, so long as the shape can be defined by an x-y directional pattern and have a z-directional depth. The spaces between the M-shape and the ring of the design 180 are the design-shaped void 185. In FIG. 7, the layer 120 of synthetic leather has been laser-ablated in an x-y shape to vaporize the portions of the synthetic leather to form the design-shaped void 185 that extends a prescribed distance into the synthetic leather and outlines the design 180. The design 180 is the non-vaporized (in other words, the non-ablated) portions of the synthetic leather which provides the three-dimensional portion of the design 180. As illustrated in FIG. 7, the resulting M-shape and ring encompassing the M-shape have softened and not-well-defined edges. To further define the edges and shape of the design 180, a tool can be inserted into the design-shaped void 185.

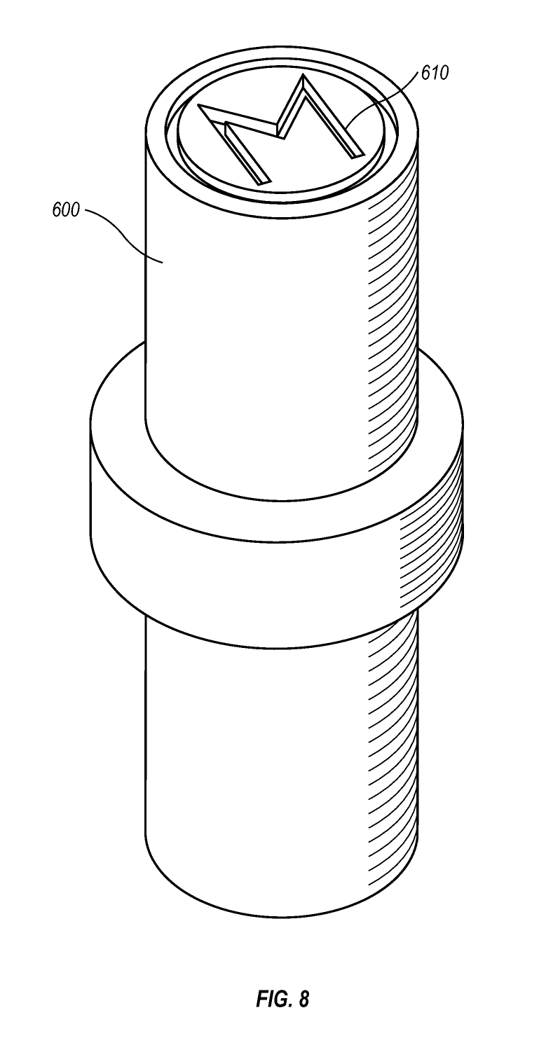

FIG. 8 is an illustration of an exemplary tool 600 that can be inserted into the ablated design-shaped void 185 of the synthetic leather depicted in FIG. 7. As seen in FIG. 8, the tool 600 is an imprinting tool. On one end of the tool 600 is a stamp 610 that corresponds to the design 180 that is ablated on the synthetic leather. In the particular example illustrated in FIG. 8, the stamp 610 is an M-shape encompassed by a ring. The recesses of the stamp 610 correspond to the three-dimensional portions of the design 180 that protrude away from the design-shaped void 185. Thus, the tool 600 has a substantial conformance fit with the design 180 and the design-shaped void 185. The tool 600 can be a hand tool whereby an individual manually inserts the tool 600 into the design-shaped void 185 of the synthetic leather. Alternatively, the tool 600 can be a component of an imprinting apparatus that mechanically inserts the tool 600 into the design-shaped void 185. For example, the imprinting apparatus can be a Teflon sleeve or bushing through which the tool 600 is guided for insertion into the design-shaped void 185. In FIG. 7, the tool 600 is made of aluminum. However, one of ordinary skill will appreciate that the tool 600 can be made of steel, stainless steel, brass, or any other metal can be heated and maintained at a high temperature. Additionally, the tool 600 can be made of a metal that is robust so that the tool 600 can be repeatedly used to imprint a three-dimensional design on synthetic materials with minimal damage to the tool 600.

After a strike-zone portion 170 of a layer 120 of synthetic leather has been laser-ablated, a tool 600 such as illustrated in FIG. 8 is inserted into the design-shaped void 185 of the synthetic leather. As the tool 600 has a stamp 610 having a substantial conformance fit with the design 180 and the design-shaped void 185 of the laser-ablated synthetic leather, the edges and shape of the design 180 is more defined than the just the laser-ablated design. As a result of inserting the tool 600 into the laser-shaped void 185 of the design 180 on the synthetic leather, a substantially distortion-free imprint of the design 180 is formed on the synthetic leather. One of ordinary skill in the art will appreciate that the tool 600 illustrated in FIG. 8 is by way of example, and other tools or apparatuses that have a substantial conformance fit with the design-shaped void 185 made by laser ablation is considered within the disclosure.

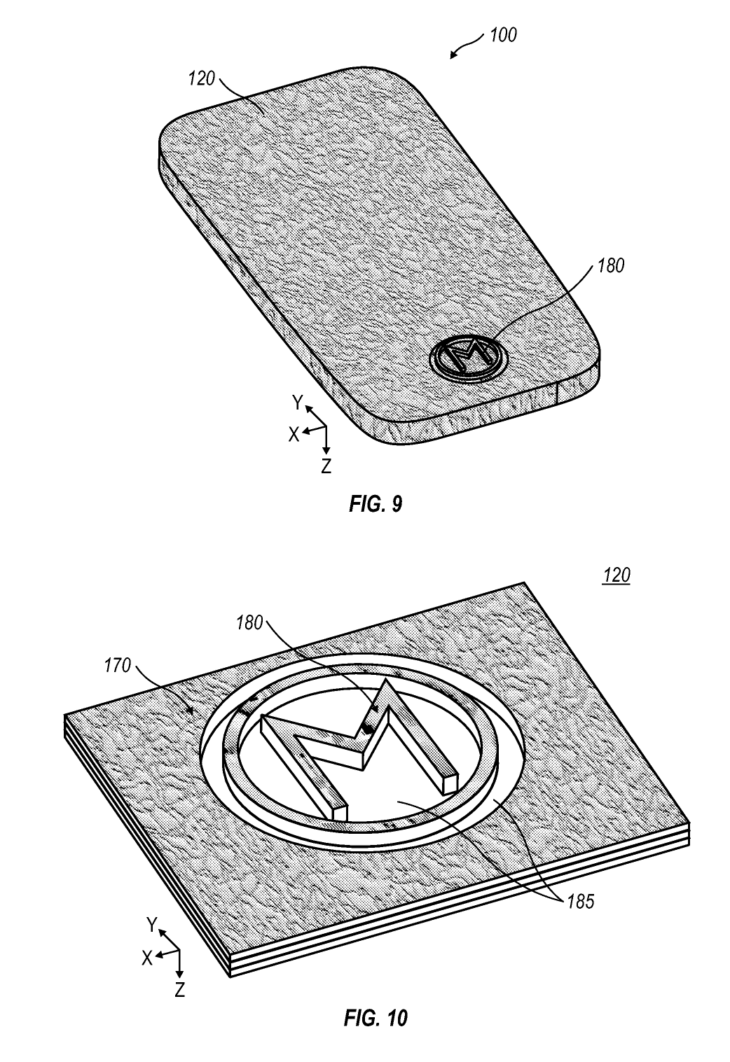

An example of a design 180 that has been laser-ablated and then stamped using the exemplary tool 600 shown in FIG. 8 is illustrated in FIG. 9. In FIG. 9, after the tool 600 has been inserted into the design-shaped void 185 of the laser-ablated layer 120 of synthetic leather, the resulting M-shape design 180 and the ring encompassing the M-shape is more defined than the laser-ablated design 180 illustrated in FIG. 7.

In at least one implementation, the tool 600 is heated to a temperature sufficient to induce plastic deformation in the synthetic material when contact-engaged by the tool 600 for a prescribed period of stamp-time. For example, the tool 600 can be heated to a 232 degrees Celsius before the tool 600 is inserted into the design-shaped void 185 of the laser-ablated layer 120 of synthetic leather. In other implementations, the tool 600 can be heated to a temperature sufficient to induce plastic deformation of the synthetic leather but less than the melting the synthetic leather. The heated tool 600 allows for the three-dimensional and protruding portions of the laser-ablated design 180 to conform to the stamp 600, thereby resulting in a more defined and distortion-free design 180 imprinted on the synthetic leather.

Additionally, the tool 600 can be inserted into the design-shaped void 185 for a prescribed period of stamp-time to ensuring that the laser-ablated design 180 substantially conforms to the stamp 610 of the tool 600, thereby resulting in a defined distortion-free imprint of the design 180 on the synthetic leather. In at least one implementation, the stamp-time can extend less than five seconds. In other implementations, the stamp-time can be one second, half a second, ten seconds, or any other stamp-time that will result in a defined distortion-free imprint of the design 180 when the tool 600 is removed from the design-shaped void 185 of the synthetic leather. Thus, one of ordinary skill in the art will appreciate that the tool 600 contacts the design-shaped void 185 momentarily or for a brief stamp-time that is sufficient to ensure that when the tool 600 is removed the resulting design 180 is substantially distortion-free.

Furthermore, when the tool 600 is inserted into the design-shaped void 185, the tool 600 is inserted with pressure. One of ordinary skill in the art will appreciate that the tool 600 be inserted into the design-shaped void 185 at a suitable pressure that is enough to leave a distortion-free imprint of the design 180 on the synthetic material but not so much that the stamp 610 of the tool passes through and cuts through the synthetic material. Thus, one of ordinary skill in the art will appreciate that the tool 600 contacts the design-shaped void 185 with at least a minimum pressure that is sufficient to ensure that when the tool 600 is removed the resulting design 180 is substantially distortion-free.

Thus, as described above, a layer 120 of synthetic leather is first laser-ablated with a design 180 having an x-y shape and z-depth and outlined by a design-shaped void 185. Then, a tool 600, which can be heated, is inserted into the design-shaped void 185 of the laser-ablated design 180 with an applied pressure for a period of stamp-time and is then removed from the void 185 to leave a substantially distortion-free design 180 on the synthetic leather. The laser-ablation changes the surface of the synthetic material to form the three-dimensional design 180 into the synthetic material, and the stamping by the tool 600 allows for definition and smoother edges of the design 180. FIG. 10 is a close-up view of the laser-ablated-then-stamped design 180 imprinted on the strike-zone portion 170 of the layer 120 of synthetic leather illustrated in FIG. 9. In FIG. 10, the top surface of the design 180 has the textured surface of the synthetic leather, and the design-shaped void 185 is at least partially smoothed out as a result of the laser-ablating. As illustrated in FIG. 10, the design 180 is an x-y shape that protrudes upward from the design-shaped void 185 to give the design 180 a z-depth that has sharp defined edges. Comparing the laser-ablated-then-stamped design 180 illustrated in FIG. 10 and the traditionally heat-imprinted design 130 illustrated in FIG. 2, the laser-ablated-then-stamped design 180 in FIG. 10 is substantially distortion-free. For example, the design 180 in FIG. 10 does not have melted plastic build-ups 135 that are found in the design 130 in FIG. 2. The melted plastic build-ups 135 that can be found on synthetic leather imprinted using methods typically performed on genuine leather are reduced and can be eliminated by first laser-ablating the design and then imprinting or stamping the design as discussed hereinabove. Thus, the resulting design 180 of the method of the present disclosure is a more defined three-dimensional design that has an appearance of branded, stamped, or imprinted genuine leather.

In at least one illustrative example, the ablating laser is a fiber laser and the depth of a valley in the strike-zone portion 170 of a layer 120 of synthetic leather is approximately 0.2 millimeters. To ablate a design void 185 to the depth of the valley in the strike-zone portion 170, the fiber laser having a 20 Watt power rating can be set to a power of approximately 30% of 20 Watts. After laser ablating the design void 185 into the synthetic leather, a tool 600 can be momentarily contact-engaged with the design void 185 with one kilogram of force for less than three seconds.

In another illustrative example, if the design is to be ablated into a strike-zone portion 170 having a valley depth of approximately 0.4 millimeters, the ablating laser can be set to a power of approximately 60% of 20 Watts to ensure the design void 185 is ablated to a depth of approximately 0.4 millimeters. When the tool 600 is inserted into the design void 185, the tool 600 can be contact-engaged with the design void 185 with less than one kilogram of force for less than five seconds.

Thus, an ablating laser that is a fiber laser to be used on synthetic leather having a textured surface with a depth of approximately 0.2-0.4 millimeters can be set to between approximately 30% and 60% of 20 Watts. Additionally, the tool 600 can be contact-engaged with the resultant ablated-design void 185 for less than five seconds under less than one kilogram of force.

As discussed above, one of ordinary skill in the art will appreciate that the type of design, depth or design, and depth of the textured surface of the synthetic material affects the type of ablating laser needed to ablate the synthetic material. For example, the type of ablating laser used will depend on the depth of the textured surface of the synthetic material and the type of design to be imprinted on the synthetic material, as the laser will need to have a suitable power to ablate the textured surface to the desired depth. In some instances, the power of a particular laser can be varied to accommodate a plurality of designs and materials. In other instances, the type of laser may need to be changed in addition to the power setting to accommodate the design material. For example, lasers of a general type emit a laser beam of a given wavelength, and power settings can be controlled; but, the cutting depth can be limited by the type of laser. As described herein, the selection of laser and power is dependent upon at least one of design and depth.

Additionally, it will be appreciated that the tool 600 will be inserted into the ablated design void 185 such that the tool 600 contact-engages the void 185 for a moment. For example, the tool 600 can barely touch the void 185 with a small amount of pressure, such as less than one kilogram of force, for as few as one or two seconds.

As described in the preceding paragraphs, the method of imprinting a three-dimensional design on a synthetic material includes laser-ablating a design onto the synthetic material to vaporize the voids of the design and then imprinting the laser-ablated design by inserting a tool into the voids of the laser-ablated design, thereby forming a defined and substantially distortion-free imprint of the design on the synthetic material. The laser-ablation of the design and the imprinting of the design are performed in conjunction to form the substantially distortion-free three-dimensional design on the synthetic leather.

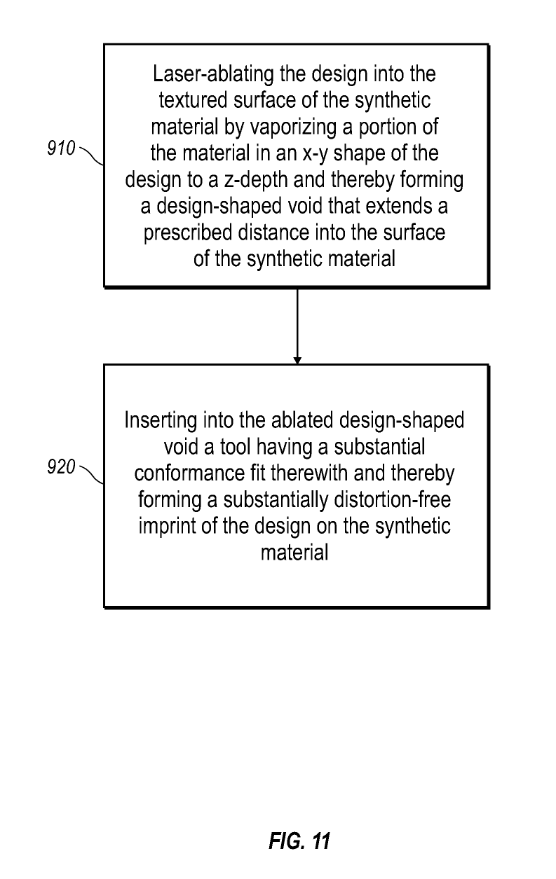

FIG. 11 is a flow chart of an exemplary method of imprinting a three-dimensional design into a textured surface of a synthetic material. At block 910, the method includes laser-ablating the design 180 into the textured surface 120 of the synthetic material by vaporizing a portion 170 of the material in an x-y shape of the design 180 to a predetermined z-depth and thereby forming a design-shaped void 185 that extends a prescribed distance into the textured surface 120 of the synthetic material. For example, as described above in relation to FIGS. 3-8, the surface of a portion of the synthetic material is positioned in the strike zone of an ablating laser, and the laser ablates an x-y shape of a design 180 into the surface to a predetermined z-depth. The laser vaporizes portions of the synthetic material to form the design-shaped void 185 that outlines the design 180 thereby providing as a three-dimensional imprint on the synthetic material. As described above, the ablating-laser is set to a particular power or strength, depending on the depth of the design 180 and the type of synthetic material that is to be ablated, and the ablating-laser ablates the design 180 onto the synthetic material. In at least one implementation, the ablating laser ablates portions of the synthetic material to a depth that is at least as deep as the valleys crossed by the design-shaped void 185.

At block 920 of FIG. 11, after the synthetic material has been laser-ablated, the method includes inserting into the ablated design-shaped void 185 a tool 600 having a substantial conformance fit therewith and thereby forming a substantially distortion-free imprint of the design 180 on the synthetic material. For example, at block 920, a tool 600 such as the one illustrated in FIG. 8 is inserted with an amount of pressure into the design-shaped void 185 formed by the ablating laser to ensure a conformance fit of the tool 600 with the design-shaped void 185 and the three-dimensional portions of the design 180. In at least one implementation, the method can also include heating the tool 600 to a temperature sufficient to induce plastic deformation in the synthetic material when contact-engaged by the tool 600 for a prescribed period of stamp-time. In another implementation, the tool can be heated to a temperature sufficient to induce permanent plastic deformation in the synthetic material. Additionally, the method can also include removing the tool 600 from the design-shaped void 185 thereby leaving a substantially distortion-free imprint of the design in the synthetic material. Thus, a three dimensional design imprinted synthetic material made according to the method described above can include a textured surface having an ablated-then-stamped, distortion-free impression of a three-dimensional design that is substantially without z-dimension displaced material adjacent the x-y dimension boundaries of the design at the textured surface. Additionally, a three-dimensional design imprinted synthetic material can be manufactured so that the a distortion-free impression of a three-dimensional design that is substantially without z-dimension displaced material adjacent to the x-y dimension boundaries of the design at the textured surface by laser-ablating and inserting an imprinting tool as described herein.

While the exemplary implementations have been described hereinabove regarding a method of imprinting a three-dimensional design on a synthetic leather, the method of imprinting a three-dimensional design can be implemented on other synthetic materials such as suede, sheets of polymers having a textured layer, sheets of polyvinyl chloride having a textured layer, or the like. Various modifications to and departures from the disclosed implementations will occur to those having skill in the art. The subject matter that is intended to be within the spirit of this disclosure is set forth in the following claims.

What is claimed is:

1. A method for imprinting a three-dimensional design into a textured surface of a synthetic material, the method comprising:
laser-ablating the design into the textured surface of the synthetic material by vaporizing a portion of the material in an x-y shape of the design to a predetermined z-depth and thereby forming a design-shaped void that extends a prescribed distance into the textured surface of the synthetic material; and
inserting into the ablated design-shaped void a tool having a substantial conformance fit therewith and thereby forming a substantially distortion-free imprint of the design on the synthetic material.

2. The method as recited in claim 1, further comprising:
heating the tool to a temperature sufficient to induce plastic deformation in the synthetic material when contact-engaged by the tool for a prescribed period of stamp-time.

3. The method as recited in claim 1, further comprising:
heating the tool to a temperature sufficient to induce plastic deformation in the synthetic material when contact-engaged by the tool for a prescribed period of stamp-time and the temperature being less than the melting temperature of the synthetic material.

4. The method as recited in claim 1, further comprising:
heating the tool to a temperature sufficient to induce permanent plastic deformation in the synthetic material when contact-engaged by the tool for a prescribed period of stamp-time extending less than five seconds.

5. The method as recited in claim 1, further comprising:
positioning in the strike zone of an ablating laser, prior to the laser-ablation, a sheet of synthetic material having a textured surface characterized by peaks and valleys and during the ablation, extending the design-shaped void into the textured surface of the synthetic material at least as deep as valleys crossed by the void.

6. The method as recited in claim 1, further comprising:
positioning in the strike zone of an ablating laser, prior to the laser-ablation, a polymer sheet having a leather appearance comprising a textured surface characterized by peaks and valleys and during the ablation, extending the design-shaped void into the textured surface of the synthetic material at least as deep as valleys crossed by the void.

7. The method as recited in claim 1, further comprising:
positioning in the strike zone of an ablating laser, prior to the laser-ablation, a single layer polymer sheet of substantially uniform synthetic material into which the design-shaped void extends after ablation.

8. The method as recited in claim 1, further comprising:
applying less than one kilogram of force upon the inserted tool for less than five seconds and then removing the tool from the void.

9. A three-dimensional design imprinted synthetic material comprising:
a textured surface having an ablated-then-stamped, distortion-free impression of a three-dimensional design that is substantially without z-dimension displaced material adjacent x-y dimension boundaries of the design at the textured surface.

10. The imprinted synthetic material as recited in claim 9, wherein the textured surface is an exterior surface of a sheet of synthetic material characterized by peaks and valleys and the three-dimensional design has a depth at least as deep as valleys crossed by the design.

11. The imprinted synthetic material as recited in claim 9, wherein the textured surface is an exterior surface of a polymer sheet having a leather appearance comprising a textured surface characterized by peaks and valleys and the three-dimensional design has a depth at least as deep as valleys crossed by the design.

12. The imprinted synthetic material as recited in claim 9, wherein the textured surface is an exterior surface of a single layer polymer sheet of substantially uniform synthetic material.

13. A three-dimensional design imprinted synthetic material manufactured by the method comprising:
laser-ablating the design into a textured surface of the synthetic material by vaporizing a portion of the material in an x-y shape of the design to a predetermined z-depth and thereby forming a design-shaped void that extends a prescribed distance into the textured surface of the synthetic material; and
inserting into the ablated design-shaped void a tool having a substantial conformance fit therewith and thereby forming a distortion-free impression of the three-dimensional design that is substantially without z-dimension displaced material adjacent x-y dimension boundaries of the design at the textured surface.

14. The three-dimensional design imprinted synthetic material as recited in claim 13, wherein the manufacturing method further comprises:
heating the tool to a temperature sufficient to induce permanent plastic deformation in the synthetic material when contact-engaged by the tool for a prescribed period of stamp-time.

15. The three-dimensional design imprinted synthetic material as recited in claim 13, wherein the manufacturing method further comprises:
heating the tool to a temperature sufficient to induce plastic deformation in the synthetic material when contact-engaged by the tool for a prescribed period of stamp-time and the temperature being less than the melting temperature of the synthetic material.

16. The three-dimensional design imprinted synthetic material as recited in claim 13, wherein the manufacturing method further comprises:
heating the tool to a temperature sufficient to induce plastic deformation in the synthetic material when contact-engaged by the tool for a prescribed period of stamp-time extending less than five seconds.

17. The three-dimensional design imprinted synthetic material as recited in claim 13, wherein the manufacturing method further comprises:
positioning in the strike zone of an ablating laser, prior to the laser-ablation, a sheet of synthetic material having a textured surface characterized by peaks and valleys and during the ablation, extending the design-shaped void into the textured surface of the synthetic material at least as deep as valleys crossed by the void.

18. The three-dimensional design imprinted synthetic material as recited in claim 13, wherein the manufacturing method further comprises:
positioning in the strike zone of an ablating laser, prior to the laser-ablation, a polymer sheet having a leather appearance comprising a textured surface characterized by peaks and valleys and during the ablation, extending the design-shaped void into the textured surface of the synthetic material at least as deep as valleys crossed by the void.

19. The three-dimensional design imprinted synthetic material as recited in claim 13, wherein the manufacturing method further comprises:
positioning in the strike zone of an ablating laser, prior to the laser-ablation, a single layer polymer sheet of substantially uniform synthetic material into which the design-shaped void extends after ablation.

20. The three-dimensional design imprinted synthetic material as recited in claim 13, wherein the manufacturing method further comprises:
applying less than one kilogram of force upon the inserted tool for less than five seconds and then removing the tool from the void.
